(19) United States
(12) Patent Application Publication
(10) Pub. No.: US 2016/0027402 A1
(43) Pub. Date: Jan. 28, 2016

(54) WIRELESS COMMUNICATIONS SYSTEM, AND DISPLAY APPARATUS

(71) Applicants: Shinsuke YANAZUME, Kanagawa (JP); Hiroshi BABA, Kanagawa (JP); Hiroshi KOBAYASHI, Kanagawa (JP)

(72) Inventors: Shinsuke YANAZUME, Kanagawa (JP); Hiroshi BABA, Kanagawa (JP); Hiroshi KOBAYASHI, Kanagawa (JP)

(73) Assignee: Ricoh Company, Ltd., Tokyo (JP)

(21) Appl. No.: 14/809,691

(22) Filed: Jul. 27, 2015

(30) Foreign Application Priority Data
Jul. 28, 2014 (JP) 2014-152792

(51) Int. Cl. G09G 5/00; G06F 3/14

(52) U.S. Cl. CPC G09G 5/006; G06F 3/1446; G09G 2370/16

(57) ABSTRACT

A wireless communications system includes a display apparatus, and information terminals connected to the display apparatus via a network. The display apparatus includes a first controller to set timings to request screen information of screens displayed on the information terminals, create a screen information request to request the information terminal to transmit the screen information in accordance with the timing, and display a screen based on the transmitted screen information; and a first transmitter-receiver to transmit the screen information request to the information terminal corresponding to the timing, and receive the screen information from the corresponding terminal. Each of the information terminals includes a second controller to capture the displayed screen to create the screen information responding to the screen information request from the display apparatus; and a second transmitter-receiver to receive the screen information request, and transmit the created screen information to the display apparatus.

### BACKGROUND OF THE INVENTION

1. Field of the Invention

The disclosures discussed herein relate to a wireless communications technology.

2. Description of the Related Art

Due to availability of wireless connections, there are widely spread systems to connect an information terminal to a network to cause a projector to project a screen displayed on the information terminal. Further, there is a technology known in the art to connect a projector and two or more information terminals simultaneously via a network so as to cause the projector to simultaneously project respective screens of the two or more information terminals.

For example, Japanese Laid-open Patent Publication No. 2004-54134 (hereinafter referred to as “Patent Document 1”) discloses a technology to receive image data of respective screens displayed on two or more terminal apparatuses connected to a network, combine the image data from the two or more terminal apparatuses into image data of one screen, and output the combined image data of one screen. Hence, with such a technology, respective screens of the two or more information terminals connected to the network may be displayed as multiple screens on one display.

However, in the related art projecting technology for allowing the projector to project the screens of the information terminals via the network, the screen to be projected by the projector is updated in accordance with the currently displayed screens of the information terminals. That is, the information terminals set the timing to capture the screens, and the information terminals send their screen information to the projector based on the timing set by the corresponding information terminals.

The projector receives screen information sent from each of the information terminals. Hence, the projector may concentrate on receiving the screen information from the information terminals all at one time at certain timing at which the projector receives the screen information from information terminals. In this case, communications load on the network may increase as well as an increase of data processing load in the projector. Hence, the projector may fail to display the screen based on the screen information sent by each of the information terminals without any disturbance. Further, in some cases, the connections between the information terminals and projector may be disconnected.

For example, it is assumed that a projector, an information terminal A, and an information terminal B are connected to via a network, and the projector is configured to display screens based on screen information of the respective screens transmitted from the information terminal A and the information terminal B. When the information terminal A transmits image information (screen information) to the projector at a high frame rate to allow a communications process of the projector to be performed by communications between the projector and the information terminal A, the communications between the information terminal B and the projector may result in timeout.

### RELATED ART DOCUMENT

### Patent Document

### Patent Document 1: Japanese Laid-open Patent Publication No. 2004-54134

### SUMMARY OF THE INVENTION

Accordingly, it is a general object in one embodiment of the present invention to provide a wireless communications technology capable of receiving screen information pieces of screens of two or more information terminals via a network to simultaneously display the respective screens of the information terminals efficiently that substantially obviate one or more problems caused by the limitations and disadvantages of the related art.

According to an aspect of embodiments, there is provided a wireless communications system that includes a display apparatus; and a plurality of information terminals connected to the display apparatus via a network, the display apparatus and the information terminals communicating with one another via the network. The display apparatus includes a first controller configured to set timings to request screen information of screens displayed on the information terminals, to create a screen information request to request a corresponding one of the information terminals to transmit the screen information of the screen in accordance with the timing, and to display a screen based on the screen information transmitted from the corresponding information terminal that has transmitted the screen information request; and a first transmitter-receiver configured to transmit the screen information request created by the first controller to the information terminal corresponding to the timing, and receive the screen information transmitted from the corresponding terminal. Each of the information terminals includes a second controller configured to capture the displayed screen to create the screen information in response to the screen information request transmitted by the display apparatus; and a second transmitter-receiver configured to receive the screen information request transmitted by the display apparatus, and transmit the screen information created by the second controller to the display apparatus.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an embodiment of a wireless communications system;

FIG. 2 is a diagram illustrating a hardware configuration of a display apparatus;

FIG. 3 is a diagram illustrating a hardware configuration of an information processing terminal;

FIG. 4 is a functional block diagram illustrating embodiments of the display apparatus and the information terminal;

FIG. 5 is a diagram illustrating an example of information stored in a connection terminal manager;

FIG. 6 is a sequence diagram illustrating an example (1) of operations of the wireless communications system;

FIG. 7 is a sequence diagram illustrating an example (2) of operations of the wireless communications system;

FIG. 8 is a diagram illustrating an example of a screen update timing determination table (1);

FIG. 9 is a flowchart illustrating an example (1) of a screen update timing setting process;

FIG. 10 is a diagram illustrating an example of a screen update timing determination table (2);

FIG. 11 is a flowchart illustrating an example (2) of a screen update timing setting process;

FIG. 12 is a diagram illustrating an example of a screen update timing determination table (3);

FIG. 13 is a diagram illustrating an example of a screen update timing determination table (4);

FIG. 14 is a flowchart illustrating an example (3) of a screen update timing setting process;

FIG. 15 is a diagram illustrating an example (5) of a screen update timing determination table;

FIG. 16 is a diagram illustrating a modification of the wireless communications system;

FIG. 17 is a functional block diagram illustrating modifications of the display apparatus and the information terminal;

FIG. 18 is a functional block diagram illustrating modifications of the display apparatus and the information terminal;

FIG. 19 is a diagram illustrating an operational example of computing a change in screen information; and

FIG. 20 is a flowchart illustrating a modification of the screen update timing setting process.

### DETAILED DESCRIPTION OF THE PREFERRED EMBODIMENTS

Next, a description is given of embodiments of the present invention with reference to the accompanying drawings. The following embodiments are only examples, and are therefore not limited to these examples. Note that in the drawings, components having the same functions are provided with the same reference numbers, and a duplicated description is omitted from the specification.

### EMBODIMENTS

### Wireless Communications System

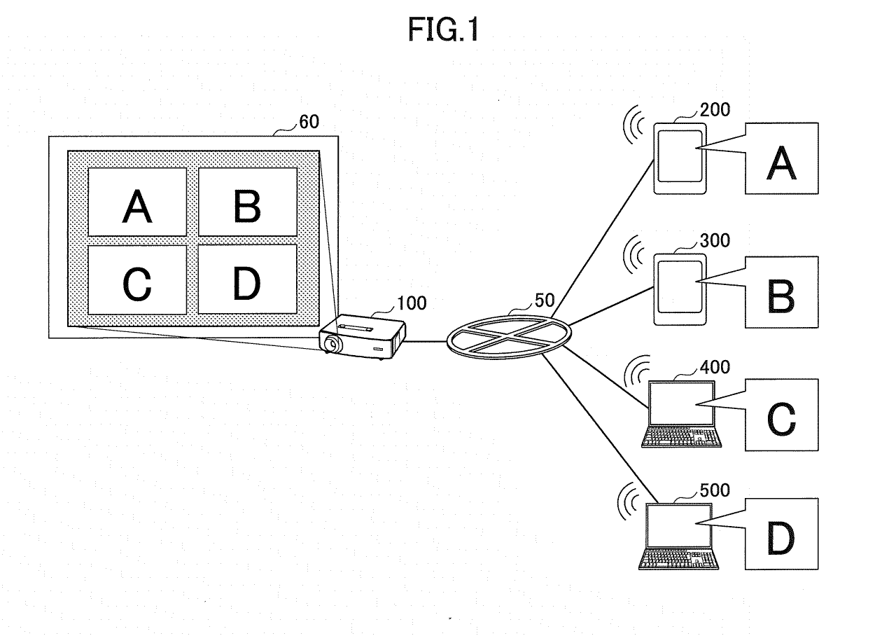

FIG. 1 illustrates an embodiment of a wireless communications system.

The wireless communications system includes a display apparatus 100 such as a projector, and a plurality of information terminals (information terminals 200 to 500). The embodiment of the wireless communications system illustrated below includes four information terminals. However, the wireless communications system may include one to three information terminals, or may include five or more information terminals. As the information terminal, a wireless communications apparatus such as a mobile terminal, a smartphone, a tablet terminal, and a note-type PC, or the like may be applied.

The display apparatus 100 and the information terminals 200 to 500 are mutually connected via a network 50. The network 50 may be formed as the Internet, an Ethernet (registered trademark), a wireless LAN (Local Area Network), a LAN by a transaction protocol such as TCP/IP, a WAN connected by using a VPN or a dedicated line, and the like. The display apparatus 100 may be connected to the network 50 either wirelessly or with wiring. Further, the information terminals 200 to 500 may be connected to the network 50 either wirelessly or with wiring.

The display apparatus 100 acquires from the information terminals 200 to 500 screen information (screen data) of respective screens displayed on the information terminals 200 to 500, processes (combines) the respective screens displayed on the information terminals 200 to 500 to be displayed on one screen, based on the screen information pieces acquired from the respective information terminals 200 to 500, and displays (projects) the processed (combined) screens onto a display area 60. In the example illustrated in FIG. 1, screen information pieces transmitted from four information terminals 200 to 500 are processed to be displayed on one screen, and the screen information pieces are displayed on respective divided areas obtained by dividing the display area 60 into two or more areas (into four areas in this example).

### Display Apparatus 100

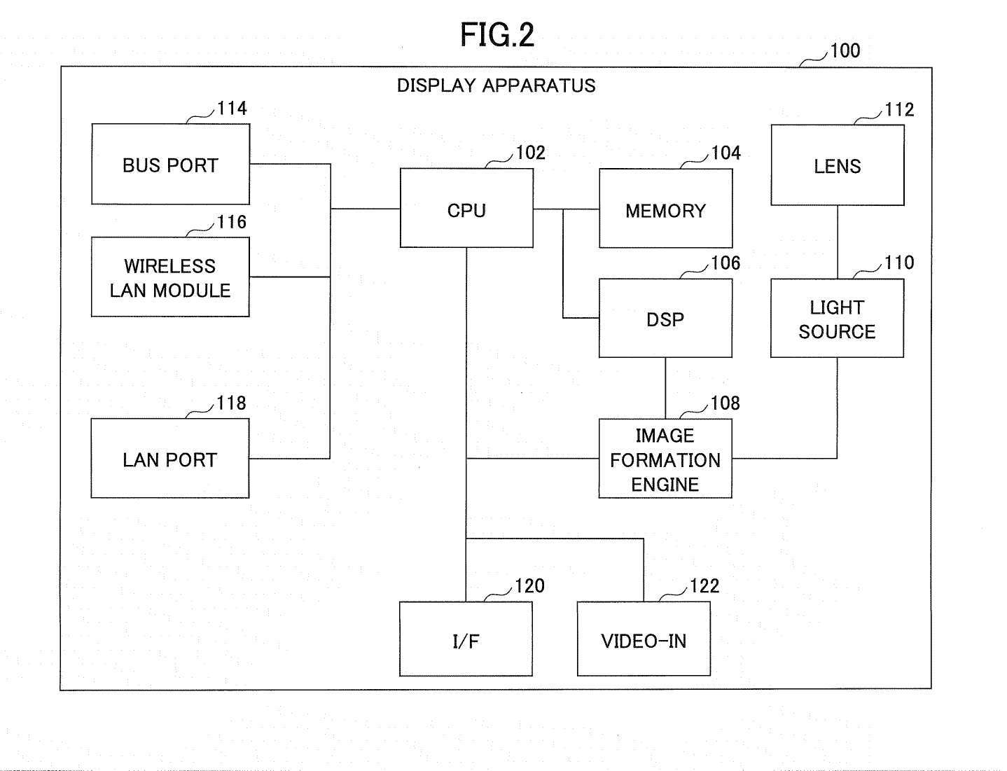

FIG. 2 is a hardware configuration diagram of the display apparatus 100 according to an embodiment. As illustrated in FIG. 2, the display apparatus 100 according to the embodiment includes a CPU (Central Processing Unit) 102 configured to control overall operations of the display apparatus 100, and a memory 104 such as a flash memory storing a display apparatus program for use in driving the CPU 102. Further, when the memory 104 is a nonvolatile memory configured to read or write data in accordance with the control of the CPU 102, the memory 104 is not limited to the flash memory. The memory 104 may be an EEPROM (Electrically Erasable and Programmable ROM), or the like. Further, the CPU 102 incorporates a not-illustrated RAM (Random Access Memory) used as a work area of the CPU 102.

The display apparatus 100 further includes a digital signal processor (DSP) 106 configured to perform a digital signal process on screen information transmitted from each of the information terminals, an image formation engine 108 configured to perform an image forming process based on the screen information obtained after the digital signal process, a light source 100 used when displaying the image forming processed screen information in the display area 60, and a lens 112.

The display apparatus 100 further includes a bus port 114 such as a universal serial bus for connecting a not-illustrated peripheral apparatus to the display apparatus 100, a wireless LAN module for connecting the display apparatus 100 to the network 50, and a LAN port 118 such as Ethernet (registered trademark). The display apparatus 100 further includes an interface (I/F) 120 such as an HDMI (High-Definition Multimedia Interface) (registered trademark), and a VIDEO-IN 122 configured to input a video signal.

### Information Terminal 200

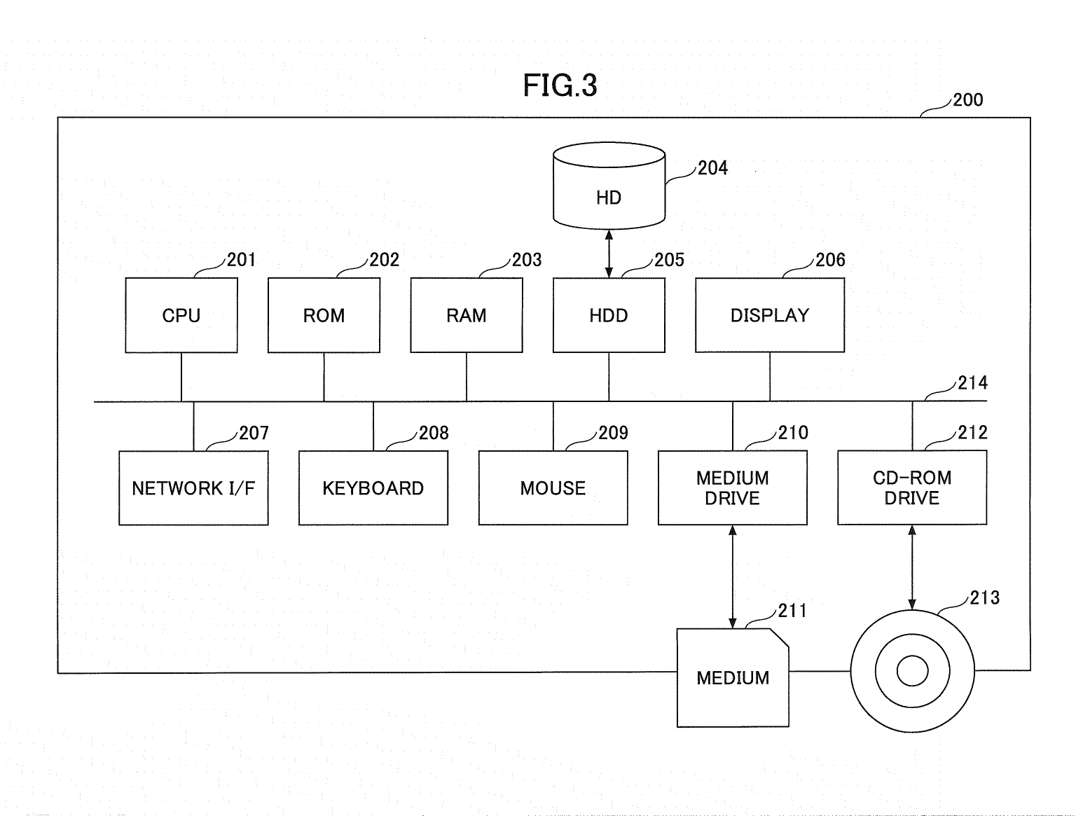

FIG. 3 is a hardware configuration diagram of the information terminal 200 according to an embodiment. The information terminal 200 includes a CPU 201 configured to control overall operations of the information terminal 200, a ROM 202 storing programs for use in driving the CPU 201, and a RAM 203 used as a work area of the CPU 201. The information terminal 200 further includes an HD 204 storing various types of data such as information terminal programs, and an HDD (Hard Disk Drive) 205 configured to control reading or writing of various types of data with respect to the HD 204 in accordance with the control of the CPU 201. The information terminal 200 further includes a display 206 configured to display various types of information such as a cursor, menus, windows, characters, and screens, and a network I/F 207 for performing data communications via the network 50.

The information terminal 200 further includes a keyboard 208 having multiple keys for use in input of characters, numerical values, various types of instructions, and the like, and a mouse 209 configured to select or execute various types of instructions, and move the cursor. The information terminal 200 further includes a medium drive 210 configured to control reading or writing (storing) of data with respect to a recording medium 211 such as a flash memory. The information terminal 200 further includes a CD-ROM drive 212 configured to control reading or writing of various types of data with respect to a CD-ROM (Compact Disc Read Only Memory) 213 serving as an example of removable recording media, and a bus line 214 such as an address bus or a data bus for electrically connecting the above-described components illustrated in FIG. 3.

Each of the information terminals 300 to 500 has a hardware configuration similar to that of the information terminal 200, and hence, a duplicated illustration of the information terminals 300 to 500 is omitted from the specification. Note that the HD 204 stores various types of data such as programs for controlling each of the information terminals.

### Functional Configurations of Embodiments

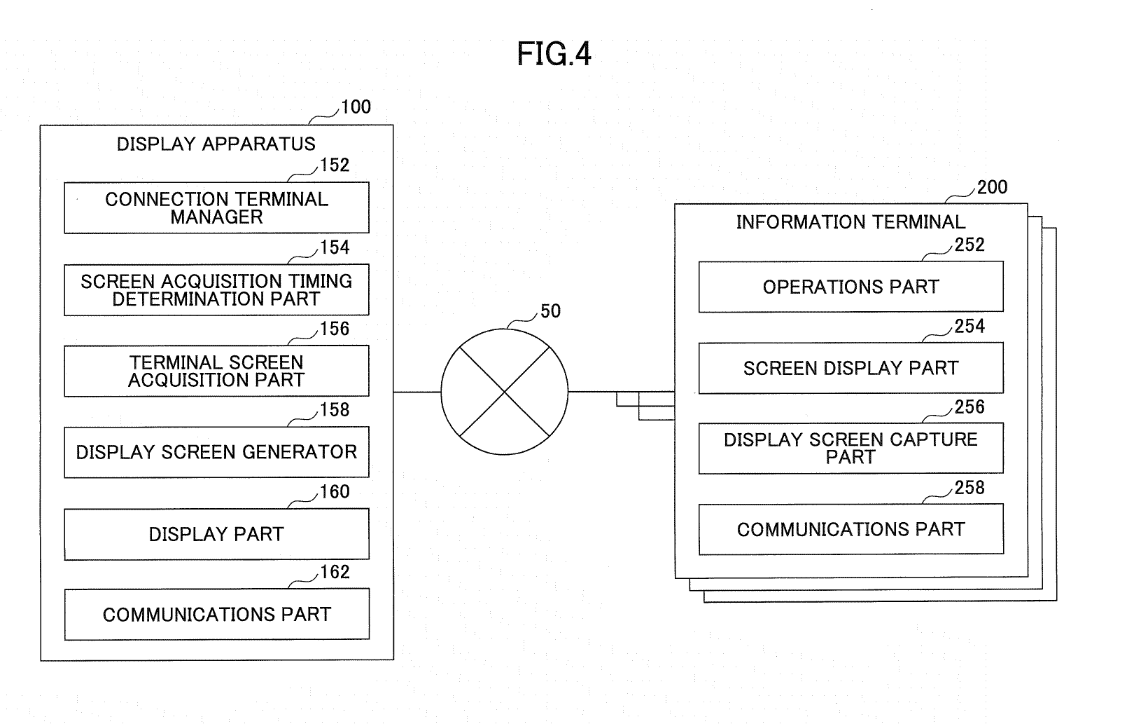

Next, a description is given of functional configurations of the embodiments. FIG. 4 is a functional block diagram illustrating the display apparatus 100 and the information terminal 200 that form the wireless communications system of the embodiment. In FIG. 4, the display apparatus 100 and the information terminal 200 are connected such that the display apparatus 100 and the information terminal 200 perform data communications via the network 50.

### Functional Configuration of Display Apparatus 100

The display apparatus 100 includes a connection terminal manager 152, a screen acquisition timing determination part 154, a terminal screen acquisition part 156, a display screen generator 158, a display part 160, and a communications part 162. The above-described components are functions or modules implemented by causing any one of the components illustrated in FIG. 2 to operate instructions from the CPU 102 in accordance with the display apparatus program loaded from the memory 104 in the RAM incorporated in the CPU 102.

### Functional Configurations of Display Apparatus 100

Next, a description is given of respective functional configurations of the display apparatus 100 with reference to FIGS. 2 and 4. Note that in the following, an illustration is also given of a relationship with main components among the components illustrated in FIG. 2 for implementing the respective functional configurations of the display apparatus 100.

The connection terminal manager 152 of the display apparatus 100 illustrated in FIG. 4 is implemented by instructions from the CPU 102 illustrated in FIG. 2, and the memory 104 illustrated in FIG. 2. The connection terminal manager 152 is connected to the display apparatus 100, and maintains information of the information terminal that displays a screen.

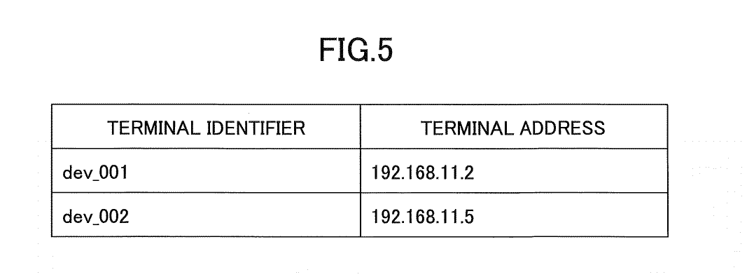

FIG. 5 illustrates an example of information stored in the connection terminal manager 152. The connection terminal manager 152 is connected to the display apparatus 100, and configured to store terminal identification information such as a terminal identifier to uniquely identify the information terminal in association with a terminal address used when the display apparatus 100 performs communications with the information terminal, for the information terminals that display respective screens. In the example of FIG. 5, the terminal identifier “dev_{—}001” is associated with the terminal address “192.168.11.2”, and the terminal identifier “dev_{—}002” is associated with the terminal address “192.168.11.5”.

The screen acquisition timing determination part 154 of the display apparatus 100 is implemented by instructions from the CPU 102 illustrated in FIG. 2. The screen acquisition timing determination part 154 is configured to determine timing for acquiring screen information pieces of respective screens displayed on the information terminals, which are to be displayed on the display apparatus 100.

The terminal screen acquisition part 156 of the display apparatus 100 is implemented by instructions from the CPU 102 illustrated in FIG. 2. The terminal screen acquisition part 156 is connected to the display apparatus 100, and configured to acquire screen information of a screen from the information terminal that displays the screen.

The display screen generator 158 of the display apparatus 100 is implemented by instructions from the CPU 102 illustrated in FIG. 2, and the DSP 106 illustrated in FIG. 2. The display screen generator 158 is configured to process the respective screen information pieces acquired from the information terminals to generate a screen to be displayed on the display apparatus 100.

The display part 160 of the display apparatus 100 is implemented by instructions from the CPU 102 illustrated in FIG. 2, and the image formation engine 108 illustrated in FIG. 2 so as to display the screen in the display area 60.

The communications part 162 of the display apparatus 100 is implemented by instructions from the CPU 102 illustrated in FIG. 2, and the wireless LAN module 116 or the LAN port 118 illustrated in FIG. 2 so as to perform communications with the respective information terminals.

### Functional Configuration of Information Terminal 200

The information terminal 200 includes a screen display part 254, a display screen capture part 256, and a communications part 258. The above-described components are functions or modules implemented by causing any one of the components illustrated in FIG. 3 to operate instructions from the CPU 201 in accordance with the information terminal programs loaded from the ROM 202 in the RAM 203.

### Functional Configurations of Information Terminal 200

Next, a description is given of respective functional configurations of the information terminal 200. Note that in the following, an illustration is also given of a relationship with main components among the components illustrated in FIG. 3 for implementing the respective functional configurations of the information terminal 200.

An operations part 252 of the information terminal 200 illustrated in FIG. 4 is implemented by instructions from the CPU 201 illustrated in FIG. 3, and the keyboard 208 and the mouse 209 illustrated in FIG. 3. The operations part 252 is configured to receive various types of inputs from users. For example, when the user operates the keyboard 208 and the mouse 209 illustrated in FIG. 3 to transmit a connection request, the operations part 252 illustrated in FIG. 4 receives the connection request.

The screen display part 254 of the information terminal 200 is implemented by instructions from the CPU 201 illustrated in FIG. 3, and the display 206 illustrated in FIG. 3. The screen display part 254 displays a screen on the display 206.

The display screen capture part 256 of the information terminal 200 is implemented by instructions from the CPU 201 illustrated in FIG. 3. The display screen capture part 256 is configured to capture the screen displayed on the display 206 of the information terminal 200 to generate screen information.

The communications part 258 of the information terminal 200 is implemented by instructions from the CPU 201 illustrated in FIG. 3, and the network I/F 207 illustrated in FIG. 3. The communications part 258 is configured to perform communications with the display apparatus 100.

### Operations of Wireless Communications System Connection Process Between Display Apparatus 100 and Information Terminal 200

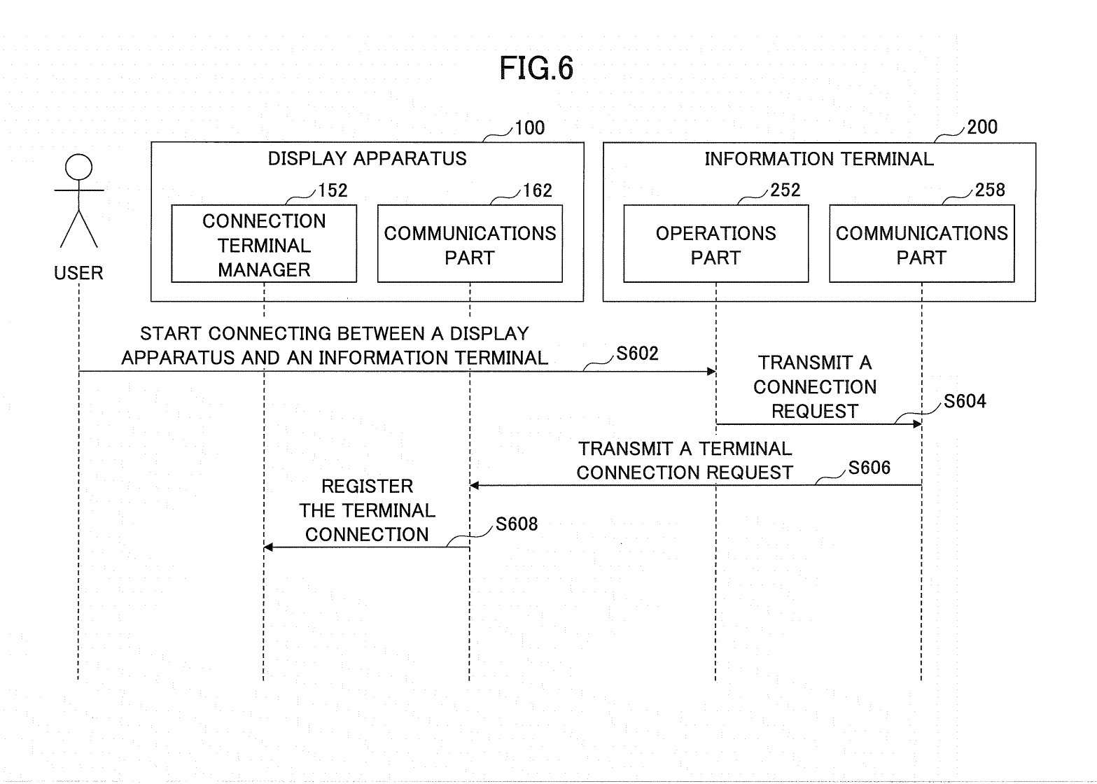

FIG. 6 illustrates a connection process between the display apparatus 100 and the information terminal 200.

In step S602, a user operates the information terminal 200 to initiate the connection process between the information terminal 200 and the display apparatus 100. For example, when the user operates the keyboard 208 and the mouse 209 illustrated in FIG. 3 to transmit a connection request, the operations part 252 receives the connection request transmitted by the user's operations.

In step S604, the operations part 252 requests the communications part 258 to transmit the connection request in accordance with the received connection request.

In step S606, the communications part 258 transmits the connection request to the display apparatus 100 in accordance with the transmission request of the connection request from the operations part 252.

In step S608, the connection request transmitted from the communications part 258 of the information terminal 200 is received by the communications part 162 of the display apparatus 100. The communications part 162 of the display apparatus 100 performs a connection process between itself (the communications part 162) and the communications part 258 of the information terminal 200 as well as registering in the connection terminal manager 152 the information terminal that transmits the connection request.

The information terminal 200 and the display apparatus 100 are connected by the above-described process. The connection process illustrated in FIG. 6 may be applied to the connection process between each of the information terminals 300 to 500 and the display apparatus 100.

### Process of Causing the Display Apparatus 100 to Display Respective Screens Displayed on Multiple Information Terminals

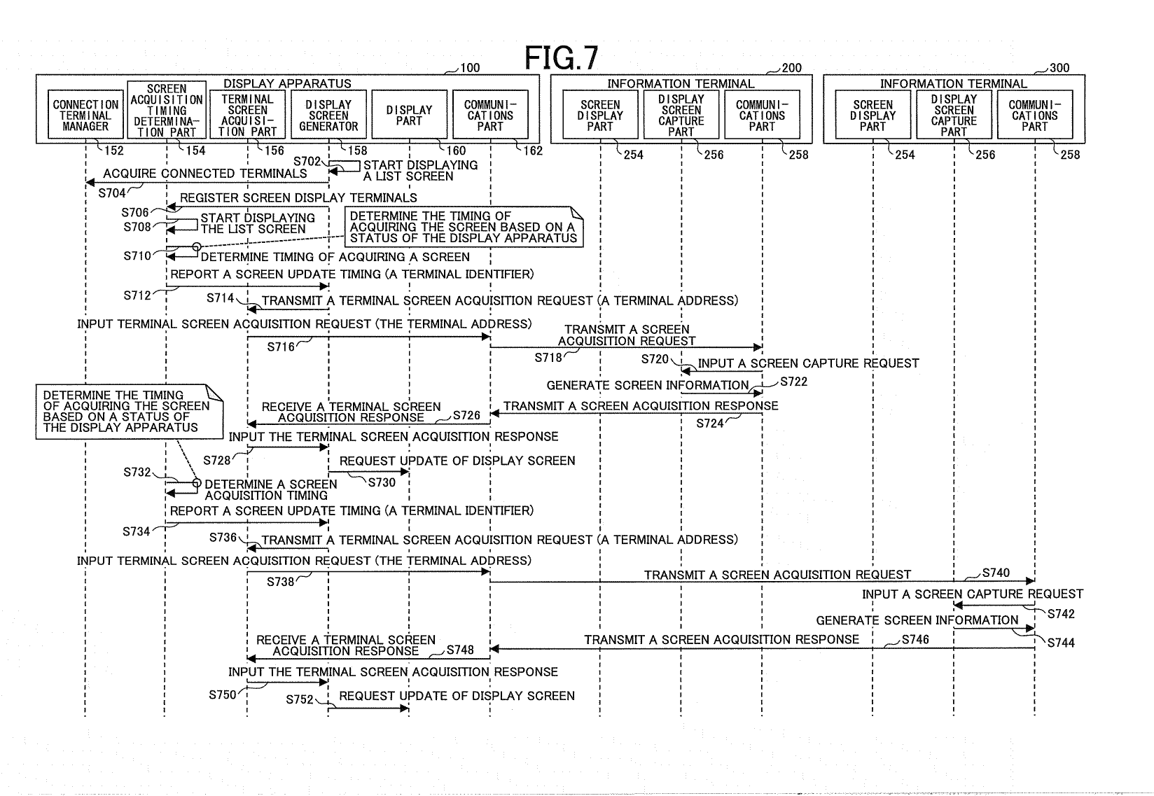

FIG. 7 illustrates a process of causing the display apparatus 100 to display respective screens of the information terminals 200 and 300. As a precondition of the process illustrated in FIG. 7, the connection process illustrated in FIG. 6 is performed between the display apparatus 100 and the information terminal 200, and between the display apparatus 100 and the information terminal 300 such that the display apparatus 100 and the information terminal 200 are connected, and the display apparatus 100 and the information terminal 300 are connected.

In step S702, the display screen generator 158 of the display apparatus 100 starts displaying a list screen, which displays on one screen respective screens displayed on the information terminals 200 and 300.

In step S704, the display screen generator 158 of the display apparatus 100 acquires a list of information terminals managed by the connection terminal manager 152, that is, a list of information terminals connected to the display apparatus 100.

In step S706, the display screen generator 158 of the display apparatus 100 registers in the screen acquisition timing determination part 154 the information terminals included in the list of the information terminals acquired in step S704.

In step S708, the screen acquisition timing determination part 154 of the display apparatus 100 starts displaying the list screen. That is, the screen acquisition timing determination part 154 of the display apparatus 100 starts a process of displaying on one screen the screens respectively displayed on the information terminals registered in step S706.

In step S710, the screen acquisition timing determination part 154 of the display apparatus 100 determines timing of acquiring a screen from each of the information terminals based on a status of the display apparatus 100. The process of determining the timing of acquiring the screen from each of the information terminals is described later.

In step S712, the screen acquisition timing determination part 154 of the display apparatus 100 reports to the display screen generator 158 a screen update timing for updating a screen of each of the information terminals. For example, the screen acquisition timing determination part 154 reports an identifier of the information terminal, and a screen update timing associated with the identifier of the information terminal to the display screen generator 158.

In step S714, the display screen generator 158 of the display apparatus 100 acquires an address of the information terminal associated with the identifier of the information terminal reported in step S712 from the list of the information terminals acquired in step S704. The display screen generator 158 reports the identifier and the terminal address of the information terminal to the terminal screen acquisition part 156 so as to request the terminal screen acquisition part 156 to acquire screen information of the screen displayed on the information terminal in accordance with the screen update timing of the corresponding information terminal.

In step S716, the terminal screen acquisition part 156 of the display apparatus 100 inputs the terminal screen acquisition request with the terminal address into the communications part 162.

In step S718, the communications part 162 of the display apparatus 100 transmits the screen acquisition request to the terminal address, as a destination, accompanied with the terminal screen acquisition request input by the terminal screen acquisition part 156 in step S716.

In step S720, the screen acquisition request transmitted in step S718 is received by the communications part 258 of the information terminal 200. The communications part 258 of the information terminal 200 inputs a screen capture request to the display screen capture part 256 of the information terminal 200 in accordance with the screen acquisition request.

In step S722, the display screen capture part 256 of the information terminal 200 captures the screen displayed by the screen display part 254 of the information terminal 200 in accordance with the screen capture request input in step S720 to generate screen information. The display screen capture part 256 of the information terminal 200 inputs the screen information into the communications part 258 of the information terminal 200.

In step S724, the communications part 258 of the information terminal 200 transmits to the display apparatus 100 a screen acquisition response accompanying the screen information input from the display screen capture part 256 of the information terminal 200.

In step S726, the screen acquisition response transmitted in step S724 is received by the communications part 162 of the display apparatus 100. The communications part 162 of the display apparatus 100 inputs into the terminal screen acquisition part 156 a terminal screen acquisition response accompanying the screen information attached to the screen acquisition response.

In step S728, the terminal screen acquisition part 156 of the display apparatus 100 inputs into the display screen generator 158 the terminal screen acquisition response input from the communications part 162 in step S726.

In step S730, the display screen generator 158 of the display apparatus 100 requests the display part 160 of the display apparatus 100 to update the displayed screen in accordance with the terminal screen acquisition response input from the terminal screen acquisition part 156 in step S728.

Thereafter, the display part 160 of the display apparatus 100 updates the screen displayed in the display area 60 in accordance with the update of the screen requested by the display screen generator 158.

In step S732, the screen acquisition timing determination part 154 of the display apparatus 100 determines timing of acquiring a screen from each of the information terminals based on a status of the display apparatus 100. The process of determining the timing of acquiring the screen from each of the information terminals is described later.

In step S734, the screen acquisition timing determination part 154 of the display apparatus 100 reports to the display screen generator 158 a screen update timing for each of the information terminals. For example, the screen acquisition timing determination part 154 reports an identifier of the information terminal, and a screen update timing associated with the identifier of the information terminal to the display screen generator 158.

In step S736, the display screen generator 158 of the display apparatus 100 acquires an address of the information terminal associated with the identifier of the information terminal reported in step S734 from the list of the information terminals acquired in step S704. The display screen generator 158 reports the identifier and the terminal address of the information terminal to the terminal screen acquisition part 156 so as to request the terminal screen acquisition part 156 to acquire screen information of the screen displayed on the information terminal in accordance with the screen update timing of the corresponding information terminal.

In step S738, the terminal screen acquisition part 156 of the display apparatus 100 inputs the terminal screen acquisition request with the terminal address into the communications part 162.

In step S740, the communications part 162 of the display apparatus 100 transmits the screen acquisition request to the terminal address, as a destination, accompanied with the terminal screen acquisition request input by the terminal screen acquisition part 156 in step S738.

In step S742, the screen acquisition request transmitted in step S740 is received by the communications part 258 of the information terminal 300. The communications part 258 of the information terminal 300 inputs a screen capture request to the display screen capture part 256 of the information terminal 300 in accordance with the screen acquisition request.

In step S744, the display screen capture part 256 of the information terminal 300 captures the screen displayed by the screen display part 254 of the information terminal 300 in accordance with the screen capture request input in step S742 to generate screen information. The display screen capture part 256 of the information terminal 300 inputs the screen information into the communications part 258 of the information terminal 300.

In step S746, the communications part 258 of the information terminal 300 transmits to the display apparatus 100 a screen acquisition response accompanying the screen information input from the display screen capture part 256 of the information terminal 300.

In step S748, the screen acquisition response transmitted in step S726 is received by the communications part 162 of the display apparatus 100. The communications part 162 of the display apparatus 100 inputs into the terminal screen acquisition part 156 a terminal screen acquisition response accompanying the screen information attached to the screen acquisition response.

In step S750, the terminal screen acquisition part 156 of the display apparatus 100 inputs into the display screen generator 158 the terminal screen acquisition response input from the communications part 162 in step S748.

In step S752, the display screen generator 158 of the display apparatus 100 requests the display part 160 of the display apparatus 100 to update the displayed screen in accordance with the terminal screen acquisition response input from the terminal screen acquisition part 156 in step S750.

Thereafter, the display part 160 of the display apparatus 100 updates the screen displayed in the display area 60 in accordance with the update of the screen requested by the display screen generator 158.

FIG. 7 illustrates a case where the display apparatus displays respective screens displayed on the two information terminals. However, the example of FIG. 7 may be applied to a case where the display apparatus displays respective screens displayed on three or more information terminals. Specifically, after the information terminals and the display apparatus are connected, processes in steps S710 to S730 are performed.

### Process of Determining Screen Acquisition Timing (1)

The screen acquisition timing determination part 154 of the display apparatus 100 includes a screen update timing determination table (1) that associates a communications status between each of the information terminals and the display apparatus 100 with a corresponding screen acquisition timing.

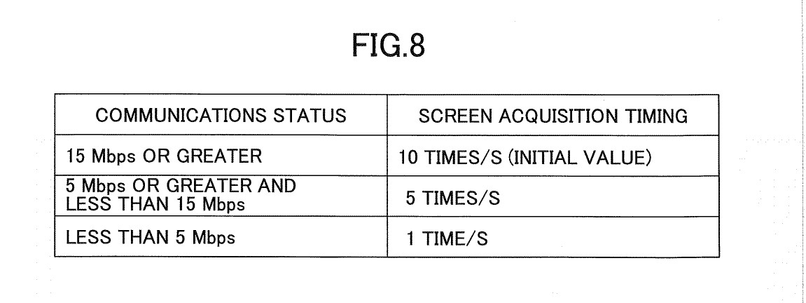

FIG. 8 illustrates an example of the screen update timing determination table (1). In the example illustrated in FIG. 8, a throughput at the time of receiving the screen information as the communications status is associated with the number of acquired information pieces per unit time (one second) as a screen acquisition timing. For example, when a throughput at the time of receiving the screen information is 15 Mbps or greater, the screen information is acquired ten times per second. When a throughput at the time of receiving the screen information is 5 Mbps or greater and less than 15 Mbps, the screen information is acquired five times per second. When a throughput at the time of receiving the screen information is less than 5 Mbps, the screen information is acquired once per second. The screen update timing determination table (1) illustrated in FIG. 8 is merely an example, and the communications status may be divided into two types, or may be divided into four or more types.

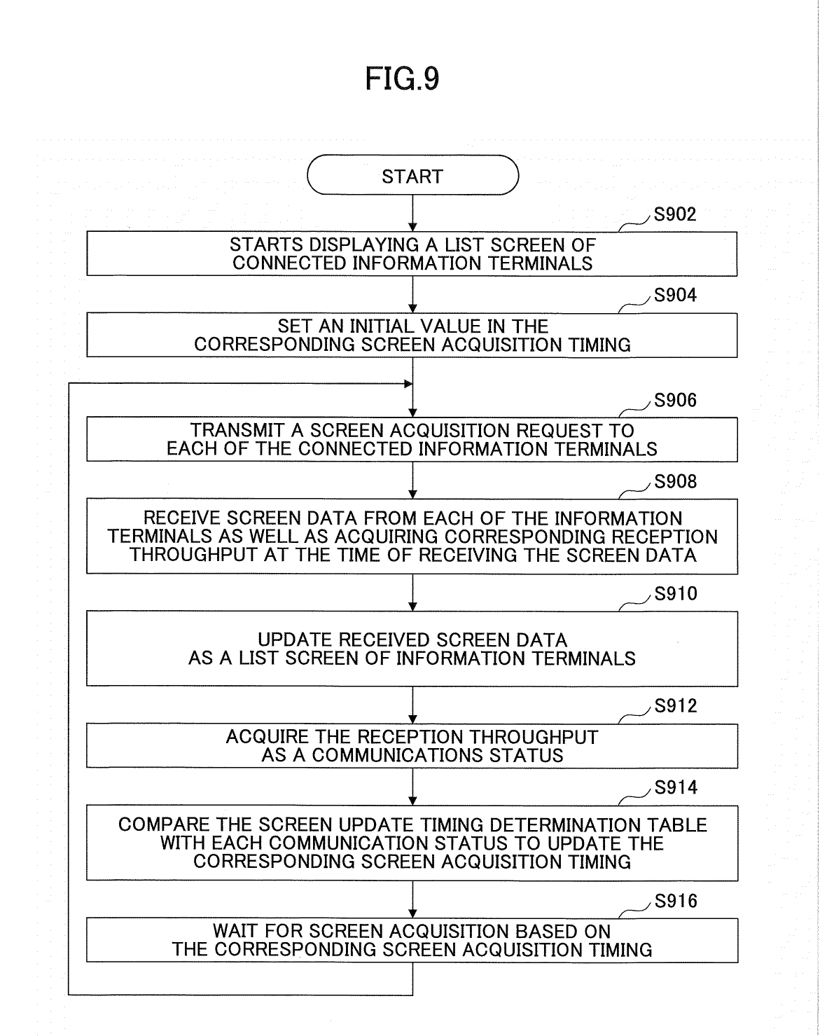

FIG. 9 is a flowchart illustrating an example (1) of a screen update timing setting process.

In step S902, the screen acquisition timing determination part 154 of the display apparatus 100 starts displaying a list screen, which displays on one screen respective screens displayed on the connected information terminals.

In step S904, the screen acquisition timing determination part 154 of the display apparatus 100 sets an initial value in the screen acquisition timing. The initial value may be set in advance, or a value input by a user who has been encouraged to input may be set as the initial value.

In step S906, the screen acquisition timing determination part 154 of the display apparatus 100 reports the initial value of the screen acquisition timing to the display screen generator 158. The display screen generator 158 inputs the terminal screen acquisition request into the terminal screen acquisition part 156 in accordance with the initial value of the screen acquisition timing. The terminal screen acquisition part 156 transmits the screen acquisition request from the communications part 162 in accordance with the terminal screen acquisition request input by the display screen generator 158.

In step S908, the screen acquisition request transmitted in step S906 is received by the information terminals. Each of the information terminals captures a displayed screen in accordance with the screen acquisition request transmitted from the display apparatus 100, and transmits a screen acquisition response accompanying screen information of the captured screen to the display apparatus 100. The communications part 162 of the display apparatus 100 receives the screen acquisition response transmitted from each of the information terminals as well as measuring a corresponding one of reception throughputs at the time of receiving the corresponding screen acquisition response to acquire the measured reception throughput. That is, the communications part 162 monitors the reception throughputs.

In step S910, each of the screen acquisition responses received by the communications part 162 of the display apparatus 100 is input into the terminal screen acquisition part 156. The terminal screen acquisition part 156 inputs each of the screen acquisition responses input by the communications part 162 into the display screen generator 158. The display screen generator 158 acquires the screen information from each of the screen acquisition responses input from the terminal screen acquisition part 156, and inputs the acquired screen information into the display part 160 so as to request updating the displayed screens.

In step S912, the screen acquisition timing determination part 154 of the display apparatus 100 sets each of the reception throughputs acquired in step S908 as a communications status.

In step S914, the screen acquisition timing determination part 154 of the display apparatus 100 refers to a screen update timing determination table (1) illustrated in FIG. 8, and updates the corresponding screen acquisition timing with that corresponding to the reception throughput acquired in step S908.

In step S916, the screen acquisition timing determination part 154 of the display apparatus 100 waits for acquiring a screen in accordance with the corresponding screen acquisition timing set in step S914.

In the process illustrated in FIG. 9, the display apparatus 100 may be able to set a timing for acquiring screen information of each of the screens from the information terminals based on a corresponding one of the communications statuses such as the reception throughputs.

### Process of Determining Screen Acquisition Timing (2)

The screen acquisition timing determination part 154 of the display apparatus 100 includes a screen update timing determination table (2) that associates an indicator representing a load such as a process load status (load average) of the display apparatus 100 with a corresponding screen acquisition timing.

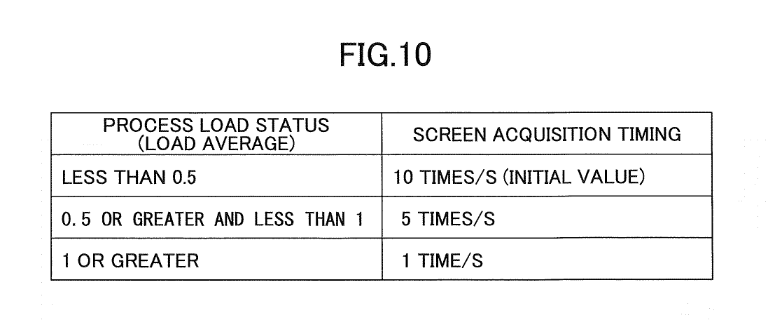

FIG. 10 illustrates an example of the screen update timing determination table (2). In the example illustrated in FIG. 10, the average number of executed processes (process load average) of the display apparatus 100 as an indicator representing a load is associated with the number of times the screen information is acquired per unit time (per second) as a screen acquisition timing. In general, the process load status is defined as a high load when the average number of the executed processes exceeds the number of CPUs implemented in the display apparatus 100. When the process load status is less than 0.5, the screen information is acquired ten times per second. When the process load status is 0.5 or greater and less than 1, the screen information is acquired five times per second. 0.5. When the process load status is 1 or greater, the screen information is acquired once per second. The screen update timing determination table (2) illustrated in FIG. 10 is merely an example, and the indicator representing the load may be divided into two types, or may be divided into four or more types. Alternatively, the utilization rate of the CPU may be used as the indicator representing the load.

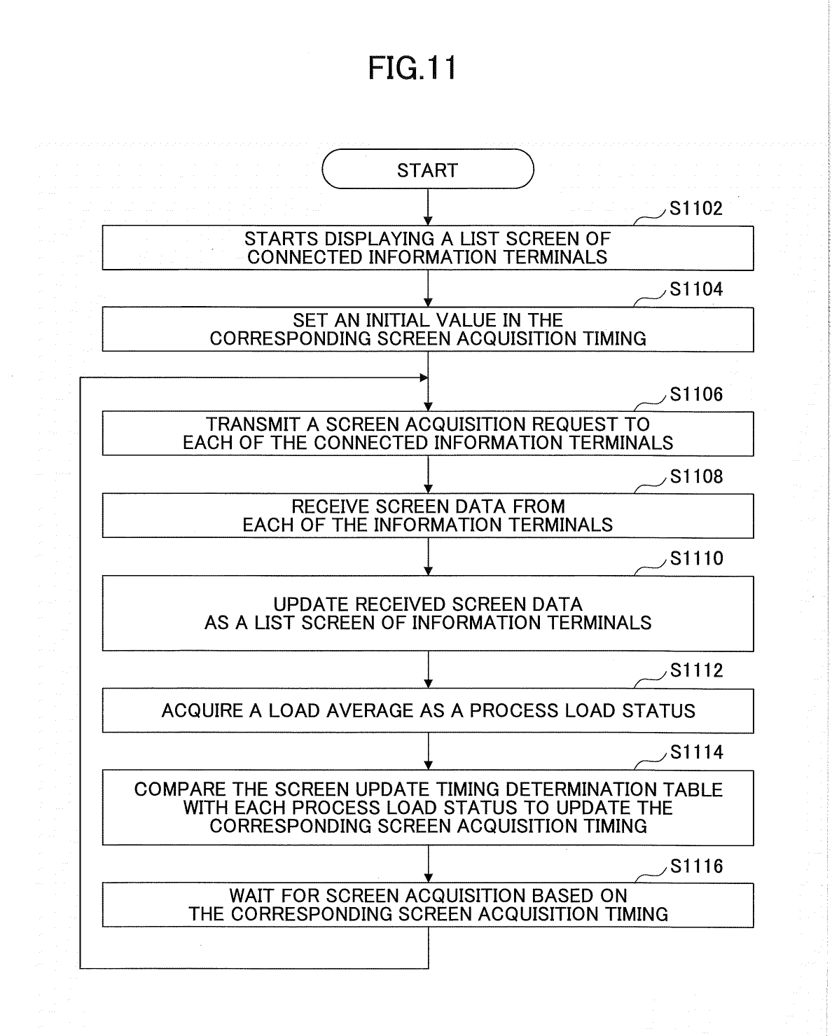

FIG. 11 is a flowchart illustrating an example (2) of a screen update timing setting process.

In step S1102, the screen acquisition timing determination part 154 of the display apparatus 100 starts displaying the list screen of the connected information terminals.

In step S1104, the screen acquisition timing determination part 154 of the display apparatus 100 sets an initial value in the screen acquisition timing. The initial value may be set in advance, or a value input by a user who has been encouraged to input may be set as the initial value.

In step S1106, the screen acquisition timing determination part 154 of the display apparatus 100 reports the initial value of the screen acquisition timing to the display screen generator 158. The display screen generator 158 inputs the terminal screen acquisition request into the terminal screen acquisition part 156 in accordance with the initial value of the screen acquisition timing. The terminal screen acquisition part 156 transmits the screen acquisition request from the communications part 162 in accordance with the terminal screen acquisition request input by the display screen generator 158.

In step S1108, the screen acquisition request transmitted in step S1106 is received by the information terminals. Each of the information terminals captures a displayed screen in accordance with the screen acquisition request transmitted from the display apparatus 100, and transmits a screen acquisition response accompanying screen information of the captured screen to the display apparatus 100. The communications part 162 of the display apparatus 100 receives a screen acquisition response transmitted from the corresponding information terminal.

In step S1110, each of the screen acquisition responses received by the communications part 162 of the display apparatus 100 is input into the terminal screen acquisition part 156. The terminal screen acquisition part 156 inputs each of the screen acquisition responses input by the communications part 162 into the display screen generator 158. The display screen generator 158 acquires the screen information from each of the screen acquisition responses input from the terminal screen acquisition part 156, and inputs the acquired screen information into the display part 160 so as to request updating the displayed screens.

In step S1112, the screen acquisition timing determination part 154 of the display apparatus 100 acquires each of load averages. That is, the screen acquisition timing determination part 154 monitors the load averages.

In step S1114, the screen acquisition timing determination part 154 of the display apparatus 100 refers to a screen update timing determination table (2) illustrated in FIG. 10, and updates the screen acquisition timing with that corresponding to the load average acquired in step S1112.

In step S1116, the screen acquisition timing determination part 154 of the display apparatus 100 waits to acquire a screen in accordance with the corresponding screen acquisition timing set in step S1114.

In the process illustrated in FIG. 11, the display apparatus 100 may be able to set timings for acquiring screen information of the screens from the information terminals based on the corresponding indicators representing respective loads such as process load statuses.

### Process of Determining Screen Acquisition Timing (3)

The screen acquisition timing determination part 154 of the display apparatus 100 includes a screen update timing determination table (3) that associates a communication status between each of the information terminals and the display apparatus 100 with a corresponding calculation coefficient (hereinafter called a “first calculation coefficient”) used for calculating the screen acquisition timing, and a screen update timing determination table (4) that associates a process load status (Load Average) of the display apparatus 100 with a corresponding calculation coefficient (hereinafter called a “second calculation coefficient”) used for calculating the screen acquisition timing.

The screen acquisition timing determination part 154 of the display apparatus 100 sets the screen acquisition timing by performing a computational process such as computing the product using the first calculation coefficient determined based on the initial value of the screen update timing and the screen update timing determination table (3), and the second calculation coefficient determined based on the initial value of the screen update timing and the screen update timing determination table (4). Then, the screen acquisition timing determination part 154 may be able to update the screen update timing by performing the computational process such as computing the product based on the initial value using the set screen acquisition timing, the first calculation coefficient, and the second calculation coefficient. Note that computing the product is merely an example of the computational process, and a computational process other than the computing the product may be performed for setting the screen acquisition timing.

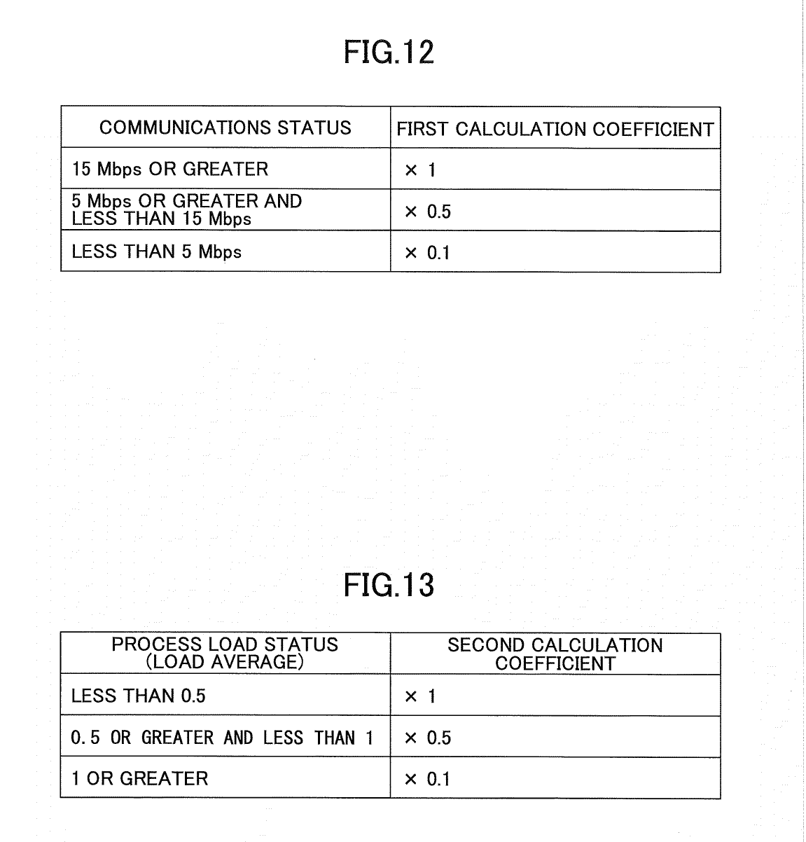

FIG. 12 illustrates an example of the screen update timing determination table (3). The example illustrated in FIG. 12 associates the throughput at the timing of receiving the screen information as the communication status with the first calculation coefficient. For example, when the throughput at the timing of receiving the screen information is 15 Mbps or greater, the first calculation coefficient is set as “1 (×1)”. When the throughput at the timing of receiving the screen information is 5 Mbps or greater and less than 15 Mbps, the first calculation coefficient is set as “1 (×0.5)”. When the throughput at the timing of receiving the screen information is less than 5 Mbps, the first calculation coefficient is set as “1 (×0.1)”. The screen update timing determination table (3) illustrated in FIG. 12 is merely an example, and the communication status may be divided into two types, or may be divided into four or more types.

FIG. 13 illustrates an example of the screen update timing determination table (4). In the example illustrated in FIG. 13, the average number of executed processes (process load status (load average)) of the display apparatus 100 as an indicator representing a load is associated with the second calculation coefficient. For example, when the process load status is less than 0.5, the second calculation coefficient is set as “1 (×1)”. When the process load status is 0.5 or greater and less than 1, the second calculation coefficient is set as “0.5 (×0.5)”. When the process load status is 1 or greater, the second calculation coefficient is set as “0.1 (×0.1)”. The screen update timing determination table (4) illustrated in FIG. 13 is merely an example, and the indicator representing the load may be divided into two types, or may be divided into four or more types. Alternatively, the utilization rate of the CPU may be used as the indicator representing the load.

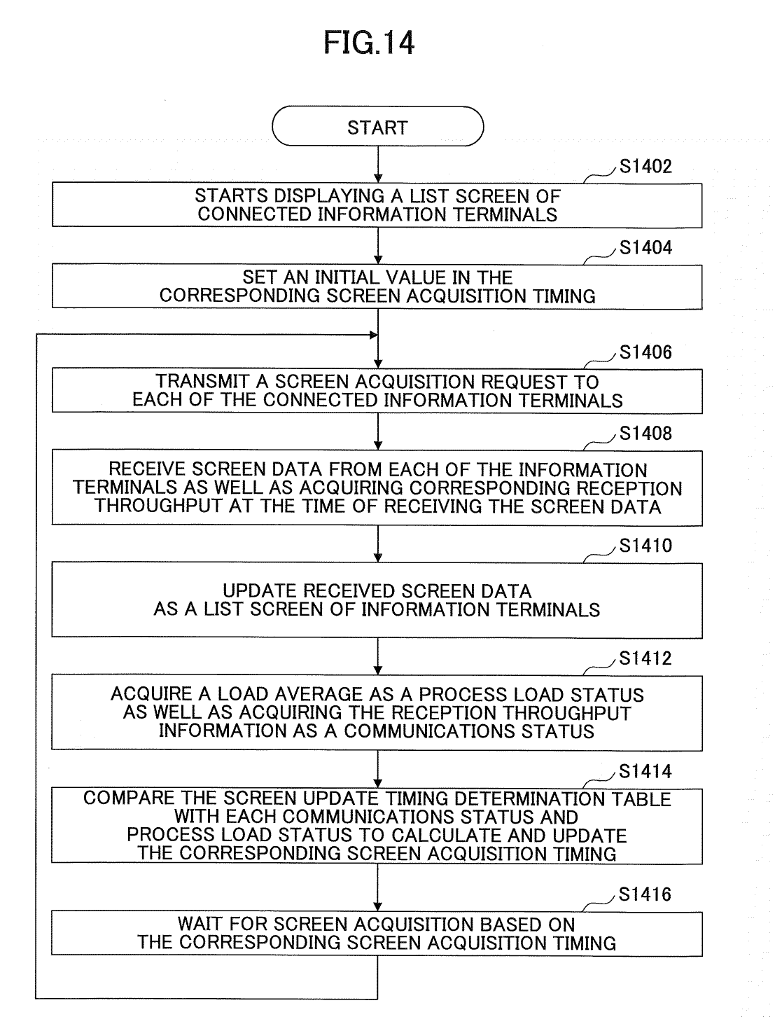

FIG. 14 is a flowchart illustrating an example (3) of a screen update timing setting process.

In step S1402, the screen acquisition timing determination part 154 of the display apparatus 100 starts displaying the list screen of the connected information terminals.

In step S1404, the screen acquisition timing determination part 154 of the display apparatus 100 sets an initial value in the screen acquisition timing. The initial value may be set in advance, or a value input by a user who has been encouraged to input may be set as the initial value.

In step S1406, the screen acquisition timing determination part 154 of the display apparatus 100 reports the initial value of the screen acquisition timing to the display screen generator 158. The display screen generator 158 inputs the terminal screen acquisition request into the terminal screen acquisition part 156 in accordance with the initial value of the screen acquisition timing. The terminal screen acquisition part 156 transmits the screen acquisition request from the communications part 162 in accordance with the terminal screen acquisition request input by the display screen generator 158.

In step S1408, the screen acquisition request transmitted in step S1406 is received by the information terminals. Each of the information terminals captures a displayed screen in accordance with the screen acquisition request transmitted from the display apparatus 100, and transmits a screen acquisition response accompanying screen information of the captured screen to the display apparatus 100. The communications part 162 of the display apparatus 100 receives the screen acquisition response transmitted from each of the information terminals as well as acquiring a corresponding one of reception throughputs at the time of receiving the corresponding screen acquisition response. That is, the communications part 162 monitors the reception throughputs.

In step S1410, each of the screen acquisition responses received by the communications part 162 of the display apparatus 100 is input into the terminal screen acquisition part 156. The terminal screen acquisition part 156 inputs each of the screen acquisition responses input by the communications part 162 into the display screen generator 158. The display screen generator 158 acquires the screen information from each of the screen acquisition responses input from the terminal screen acquisition part 156, and inputs the acquired screen information into the display part 160 so as to request updating the displayed screens.

In step S1412, the screen acquisition timing determination part 154 of the display apparatus 100 acquires each of load averages as well as setting a corresponding one of the reception throughputs acquired in step S1408 as a communications status. That is, the screen acquisition timing determination part 154 monitors the load averages.

In step S1414, the screen acquisition timing determination part 154 of the display apparatus 100 acquires the first calculation coefficient corresponding to the reception throughput set in step S1412 by referring to the screen update timing determination table (3) illustrated in FIG. 12, and acquires the second calculation coefficient corresponding to the load average acquired in step S1412 by referring to the screen update timing determination table (4) illustrated in FIG. 13. The screen acquisition timing determination part 154 multiplies the initial value of the screen acquisition timing by the first coefficient and the second coefficient to calculate a new screen acquisition timing so as to update the screen acquisition timing with the new screen acquisition timing.

In step S1416, the screen acquisition timing determination part 154 of the display apparatus 100 waits to acquire a screen in accordance with the corresponding screen acquisition timing set in step S1414.

In the process illustrated in FIG. 14, the display apparatus 100 may be able to set a timing for acquiring screen information of each of the screens displayed by the information terminals based on the reception throughputs and the indicators representing respective loads.

According to the embodiment of the wireless communications system, the display apparatus 100 and one or more information terminals are mutually connected via the network such that the display apparatus 100 and the information terminal(s) are able to communicate with one another. The display apparatus sets a timing for acquiring the screen information of the screen displayed by each of the information terminals based on the communications status of the display apparatus, and transmits screen acquisition requests to the information terminals in accordance with the respective set timings. The information terminals capture the current screens to create the screen information of the screens in response to the respective screen acquisition requests transmitted from the display apparatus 100, and transmit the created screen information of the screens to the display apparatus. The display apparatus 100 displays the screens displayed on the respective information terminals on one screen based on the screen information of the screens received from the respective information terminals. In the above configuration, the loads concentrated on the display apparatus may be reduced when the display apparatus simultaneously displays on one screen by receiving screen information of the screens displayed on the respective information terminals from the information terminals via the network. Hence, the display apparatus may be able to efficiently display the screens of the information terminals without disconnecting the connections between the display apparatus and the information terminals.

### Modification 1

A modification 1 of the wireless communications system includes a process of the screen acquisition timing determination part 154 differing from that of the screen acquisition timing determination part 154 illustrated in the above-described embodiment. The screen acquisition timing determination part 154 includes a screen acquisition timing setting table for acquiring the screen information of the screens displayed on the respective information terminals.

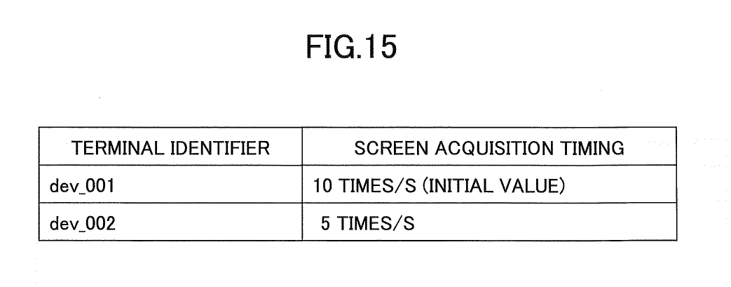

FIG. 15 illustrates an example of a screen acquisition timing setting table. The screen acquisition timing setting table includes identification information such as a terminal identifier uniquely specifying each of the information terminals connected to the display apparatus 100 and displaying respective screens in association with a corresponding one of the screen acquisition timings. In the example of FIG. 15, the terminal identifier “dev_{—}001” is associated with the screen acquisition timing “10 times/s”, and the terminal identifier “dev_{—}002” is associated with the screen acquisition timing “5 times/s”.

The screen acquisition timing determination part 154 sets a timing for acquiring the screen information of the screen displayed on each of the information terminals in accordance with the screen acquisition timing setting table.

The connection process of FIG. 6 may be applied to a connection process between the display apparatus 100 and the information terminal 200, and the process of FIG. 7 may be applied to a display process of causing the display apparatus 100 to display the screens displayed on the respective information terminals 200 and 300.

Further, the determination process of FIG. 9 may be applied to a process of determining the corresponding screen acquisition timing. Note that in step S908, the reception throughput at the time of receiving the screen data is not measured, and steps S912 and S914 are not performed.

In the modification 1 of the wireless communications system, a process of updating the screen acquisition timing is eliminated. Hence, the performance relating to the process of causing the display apparatus 100 to display the screens displayed on the respective information terminals may be improved compared to the above-described embodiment.

### Modification 2

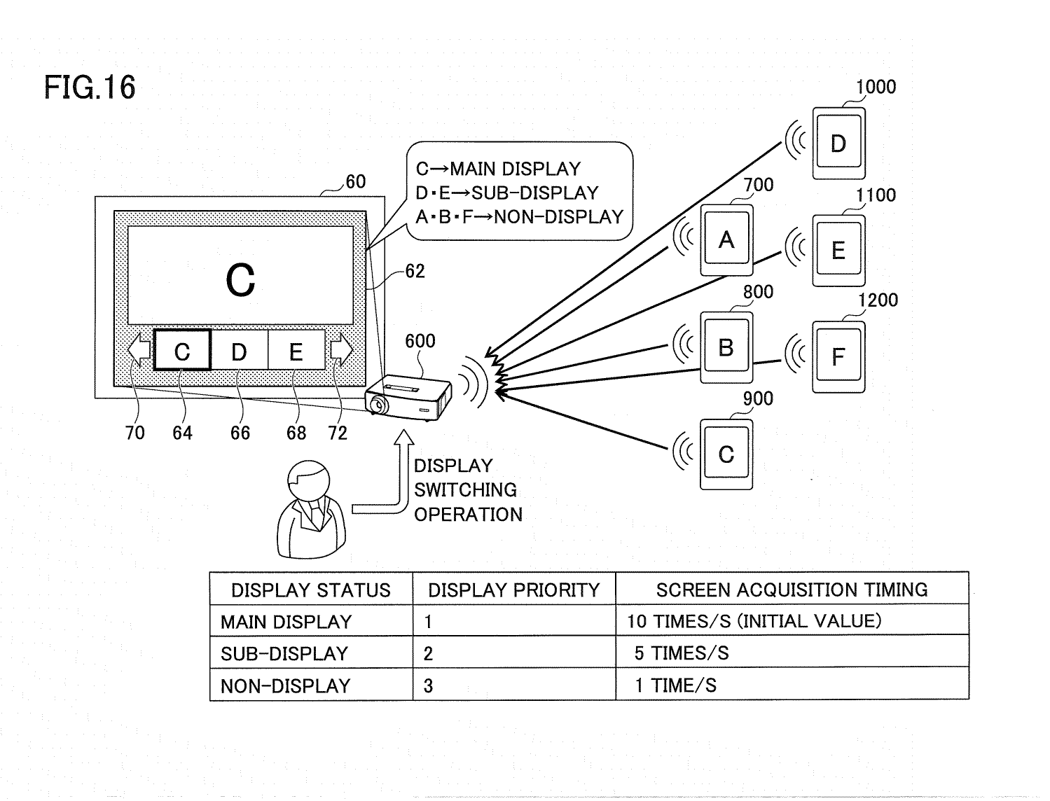

FIG. 16 illustrates a modification 2 of a wireless communications system.

The wireless communications system includes a display apparatus 600 such as a projector, and a plurality of information terminals (information terminals 700 to 1200). The modification 2 of the wireless communications system illustrated below includes six information terminals. However, the wireless communications system may include one to five information terminals, or may include seven or more information terminals. As the information terminal, a wireless communications apparatus such as a mobile terminal, a smartphone, a tablet terminal, and a note-type PC, or the like may be applied.

The display apparatus 600 and the information terminals 700 to 1200 are mutually connected via a not-illustrated network. The network may be formed as the Internet, Ethernet (registered trademark), a wireless LAN, a LAN by a transaction protocol such as TCP/IP, a WAN connected by using a VPN or a dedicated line, and the like. The display apparatus 600 may be connected to the network either wirelessly or with wiring. Further, the information terminals 700 to 1200 may be connected to the network either wirelessly or with wiring.

The display apparatus 600 acquires from the information terminals screen information of respective screens displayed on the information terminals, processes (combines) the respective screens displayed on the information terminals to be displayed on one screen, based on the screen information acquired from the respective information terminals, and displays the processed (combined) screens onto a display area 60. In the example illustrated in FIG. 16, the display area 60 is divided into a wide main area 62, and narrow sub-areas 64, 66, and 68. The screen displayed in the main area is selected from the sub-areas 64, 66, and 68. The screens displayed in the sub-areas 64, 66, and 68 are switched by selecting one of arrows 70 and 72. That is, in the example of FIG. 16, the screens transmitted from the three information terminals, among the screen information of the screens transmitted from the six information terminals, are displayed in the sub-areas 64, 66, and 68, and one of the screens displayed in the sub-areas 64, 66, and 68 is displayed in the main area 62.

When acquiring the screen information of the screens displayed on the information terminals 700 to 1200, the display apparatus 600 switches the screen acquisition timing based on whether the screens displayed on the information terminals are displayed in the main area 62, or in the sub areas 64, 66, and 68. That is, the display apparatus 600 sets the priority of updating the screens based on whether the screens displayed on the information terminals is displayed in the main area 62, or one of the sub-areas 64, 66, and 68. For example, the display apparatus 600 sets a highest priority of the screen acquisition timing for the screen to be displayed in the main area 62, and a second highest priority of the screen acquisition timing for the screens to be displayed in the sub-areas 64, 66, and 68. The display apparatus 600 sets a lowest priority of the screen acquisition timing for the non-display screens.

Specifically, the display apparatus 600 includes a display priority determination table. In the display priority determination table, as illustrated in FIG. 16, the highest display priority “1” representing the highest priority of acquiring the screen is set for the screen having the display status of “main display” to be displayed in the main area 62, and “10 times/s” is set in the screen acquisition timing. The second highest display priority “2” representing the second highest priority of acquiring the screen is set for the screens having the display status of “sub-display” to be displayed in the sub-areas 64, 66, and 68, and “5 times/s” is set in the screen acquisition timing. The lowest display priority “3” representing the lowest priority of acquiring the screen is set for the non-display screens having the display status of “non-display”, and “once/s” is set in the screen acquisition timing.

The hardware configuration of the display apparatus 600 may employ the hardware configuration of the display apparatus 100 illustrated in FIG. 2. The hardware configurations of the information terminals 700 to 1200 may employ the hardware configuration of the information terminal 200 illustrated in FIG. 3.

### Functional Configuration of Modification

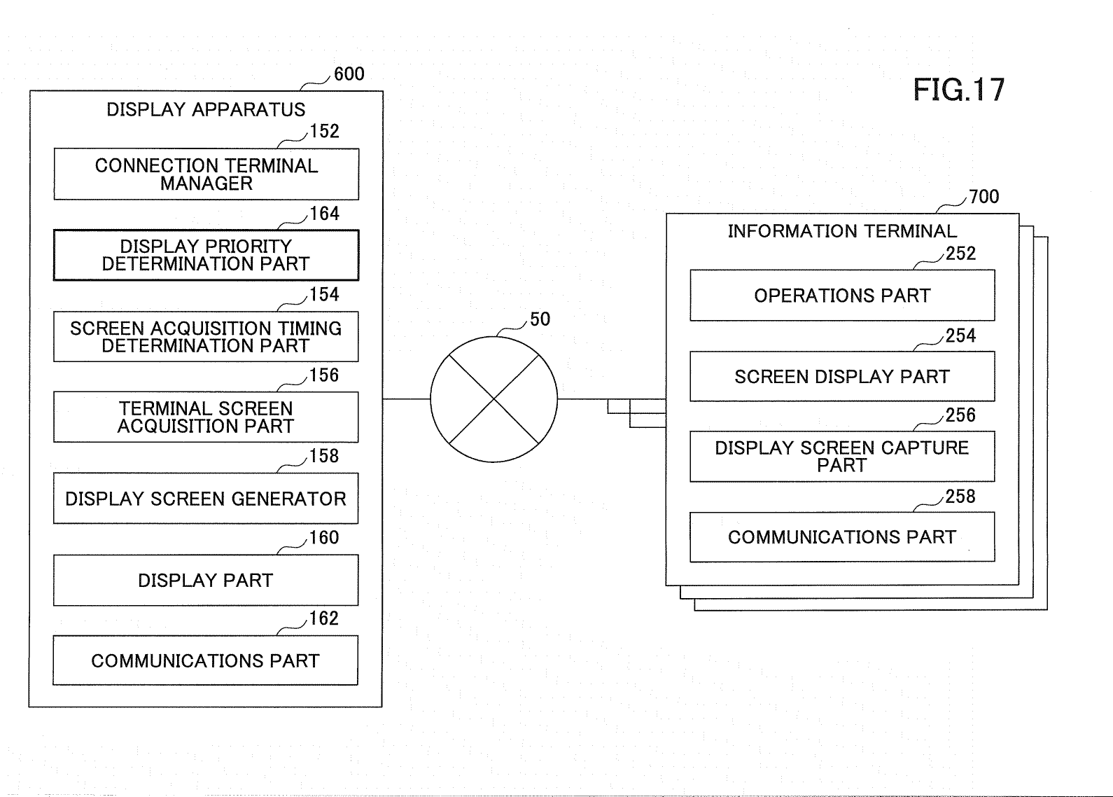

Next, a description is given of functional configurations of the modification. FIG. 17 is a functional block diagram illustrating the display apparatus 600 and the information terminal 700 that form the wireless communications system of the embodiment. In FIG. 17, the display apparatus 600 and the information terminal 700 are connected such that the display apparatus 600 and the information terminal 700 perform data communications via the network 50.

### Functional Configuration of Display Apparatus 600

The display apparatus 600 includes the connection terminal manager 152, the screen acquisition timing determination part 154, the terminal screen acquisition part 156, the display screen generator 158, the display part 160, the communications part 162, and a display priority determination part 164. The above-described components are functions or modules operated by causing any one of the components illustrated in FIG. 2 to operate instructions from the CPU 102 in accordance with the display apparatus program loaded in the RAM incorporated from the memory 104 to the CPU 102.

### Functional Configurations of Display Apparatus 600

Next, a description is given of respective functional configurations of the display apparatus 600 with reference to FIGS. 2 and 17. Note that in the following, an illustration is also given of a relationship with main components among the components illustrated in FIG. 2 for implementing the respective functional configurations of the display apparatus 600.

Among the functional components of the display apparatus 600 illustrated in FIG. 17, the connection terminal manager 152, the screen acquisition timing determination part 154, the terminal screen acquisition part 156, a display screen generator 158, the display part 160, and the communications part 162 described above may be applied to those of the display apparatus 600.

The display priority determination part 164 of the display apparatus 600 illustrated in FIG. 17 may be implemented by instructions from the CPU 102 illustrated in FIG. 2. The display priority determination part 164 includes a display priority determination table, and sets the priority of updating the screens based on whether the screens displayed on the information terminals are displayed in the main area 62, or one of the sub-areas 64, 66, and 68. The screen acquisition timing is determined based on the priority of updating the screens set by the display priority determination part 164 and the screen acquisition timing determination part 154.

The connection process of FIG. 6 may be applied to a connection process between the display apparatus 100 and the information terminal 200, and the process of FIG. 7 may be applied to a display process of causing the display apparatus 600 to display the screens displayed on the respective information terminals 200 and 300.

Further, the determination process of FIG. 9 may be applied to a process of determining the corresponding screen acquisition timing. Note that in step S904, the corresponding screen acquisition timing is set based on the display priority determination table, and in step S908, the corresponding reception throughput is not measured at the timing of receiving the screen data. Steps S912 and 914 are not performed.

According to the modification 2 of the wireless communications system, the screen acquisition timing may be set based on the areas to display the screens of the information terminals. In this configuration, the priority in the frequency of acquiring the screen information of the screen to be displayed in the wide area may be set high. Hence, the appearance quality of the screen displayed by the display apparatus 600 may be improved.

### Modification 3

According to a modification 3 of the wireless communications system, the screen acquisition timing is set based on a change in the screen information of the screen transmitted from each of the information terminals.

The modification 3 of the wireless communications system may employ the configuration of FIG. 1. However, the modification 3 of the wireless communications system includes a display apparatus 1300 instead of the display apparatus 100.

### Functional Configuration of Modification

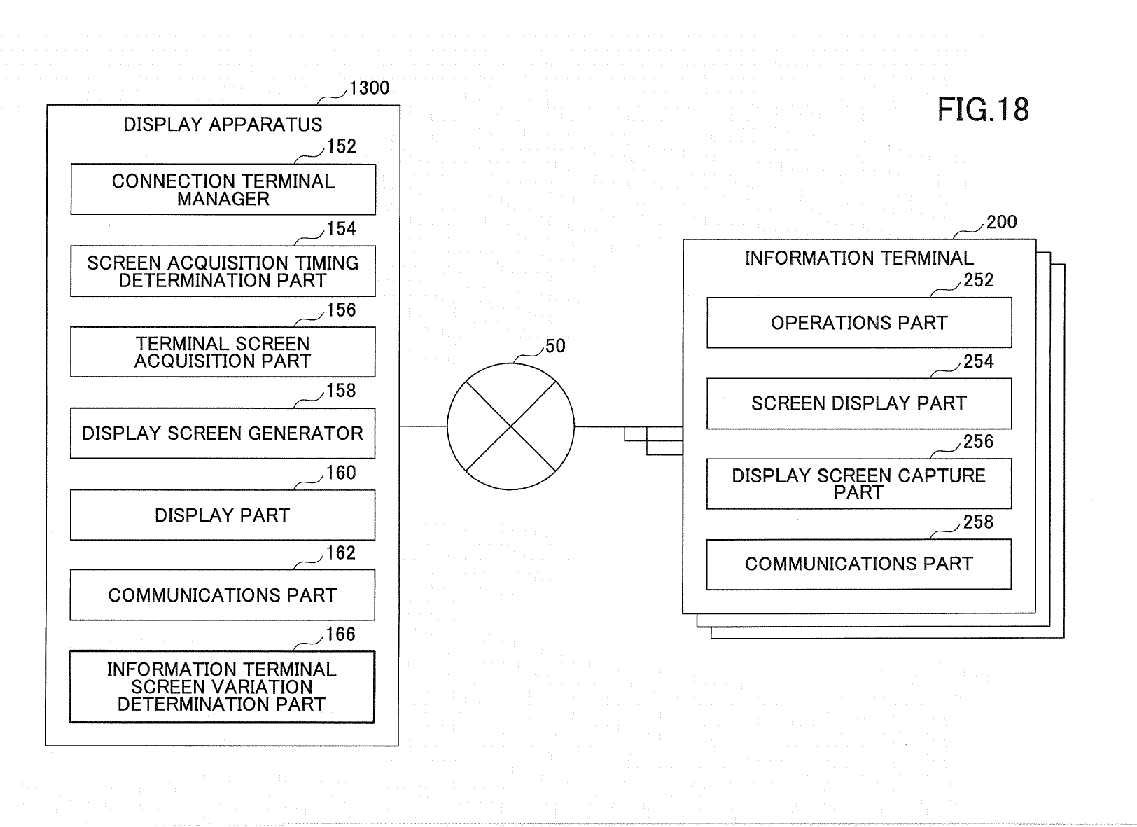

Next, a description is given of functional configurations of the modification 3. FIG. 18 is a functional block diagram illustrating the display apparatus 1300 and the information terminal 200 that form the wireless communications system of the modification 3. In FIG. 18, the display apparatus 1300 and the information terminal 200 are connected such that the display apparatus 1300 and the information terminal 200 perform data communications via the network 50.

### Functional Configuration of Display Apparatus 1300

The display apparatus 1300 includes the connection terminal manager 152, the screen acquisition timing determination part 154, the terminal screen acquisition part 156, the display screen generator 158, the display part 160, the communications part 162, and an information terminal screen variation determination part 166. The above-described components are functions or modules operated by causing any one of the components illustrated in FIG. 2 to operate on instructions from the CPU 102 in accordance with the display apparatus program loaded in the RAM incorporated from the memory 104 to the CPU 102.

### Functional Configurations of Display Apparatus 1300

Next, a description is given of respective functional configurations of the display apparatus 1300 with reference to FIGS. 2 and 18. Note that in the following, an illustration is also given of a relationship with main components among the components illustrated in FIG. 2 for implementing the respective functional configurations of the display apparatus 1300.

Among the functional components of the display apparatus 1300 illustrated in FIG. 18, the connection terminal manager 152, the screen acquisition timing determination part 154, the terminal screen acquisition part 156, a display screen generator 158, the display part 160, and the communications part 162 described above may be applied to those of the display apparatus 1300.

The information terminal screen variation determination part 166 of the display apparatus 1300 illustrated in FIG. 18 may be implemented by instructions from the CPU 102 illustrated in FIG. 2. The information terminal screen variation determination part 166 computes a change in the screen information transmitted from each of the information terminals.

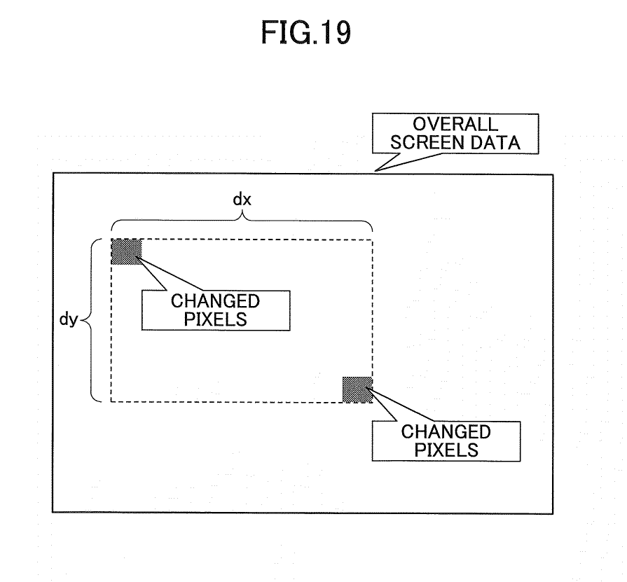

FIG. 19 is a diagram illustrating an operational example of computing a change in the screen information. The information terminal screen variation determination part 166 computes a difference between the pixels based on the previously received screen information and newly received screen information. The information terminal screen variation determination part 166 determines a minimum rectangular area enclosing changed pixels as changed screen information based on the difference between the pixels, and computes a change in the screen information based on the following formula (1).

Change in screen information=dx×dy (1)

In the formula (1), “dx” represents a number of pixels in a lateral direction (X direction) of the changed screen information, and “dy” represents a number of pixels in a vertical direction (Y direction) of the changed screen information.

The connection process of FIG. 6 may be applied to a connection process between the display apparatus 1300 and the information terminal 200, and the process of FIG. 7 may be applied to a display process of causing the display apparatus 1300 to display the screens displayed on the respective information terminals 200 and 300.

### Process of Determining Screen Acquisition Timing (4)

The information terminal screen variation determination part 166 of the display apparatus 1300 computes a change in the screen information. The screen acquisition timing determination part 154 includes a not-illustrated screen update timing determination table (5) that associates the change in the screen information and the screen acquisition timing. The screen update timing determination table (5) includes settings of the frequency of acquiring the screen information of the corresponding screen at the screen acquisition timing being increased as the change in the screen information increases, and the frequency of acquiring the screen information of the corresponding screen at the screen acquisition timing being decreased as the change in the screen information decreases.

The screen acquisition timing determination part 154 refers to the screen update timing determination table (5) to set the screen acquisition timing corresponding to the change in the screen information requested by the information terminal screen variation determination part 166.

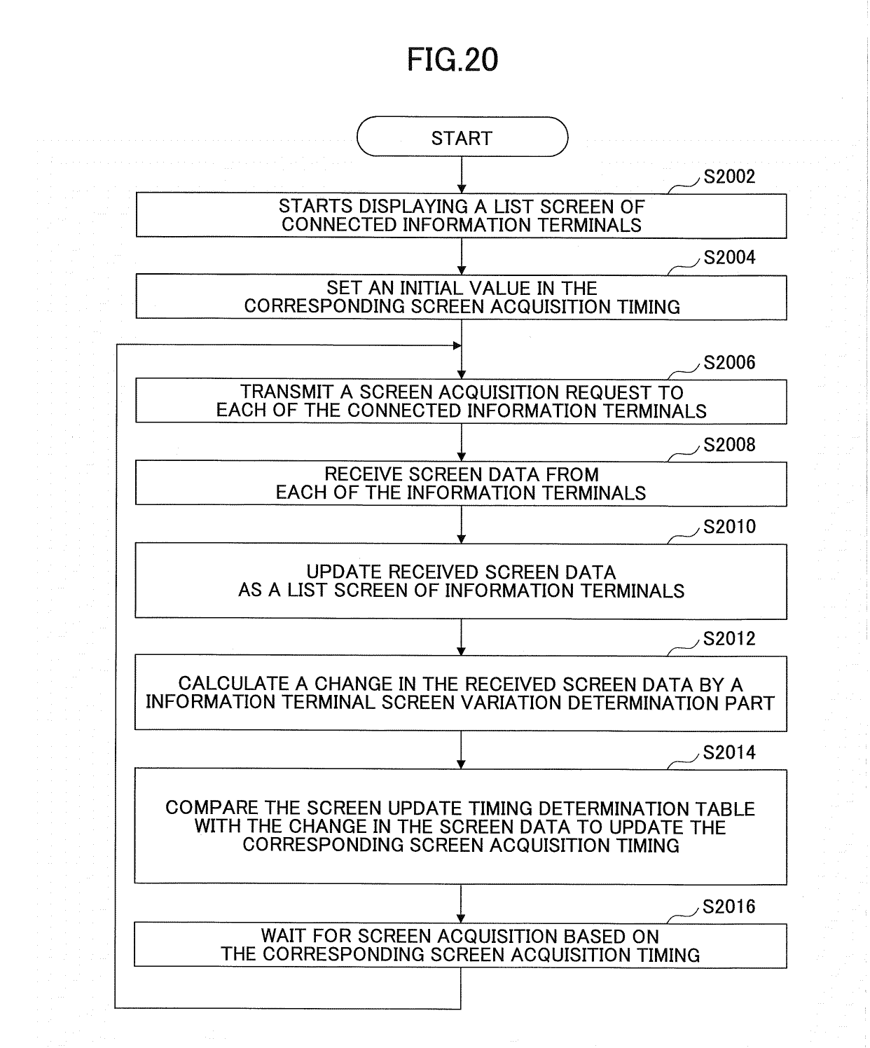

FIG. 20 is a flowchart illustrating a modification 3 of a screen update timing setting process.

In step S2002, the screen acquisition timing determination part 154 of the display apparatus 1300 starts displaying the list screen of the connected information terminals.

In step S2004, the screen acquisition timing determination part 154 of the display apparatus 1300 sets an initial value in the screen acquisition timing. The initial value may be set in advance, or a value input by a user who has been encouraged to input may be set as the initial value.

In step S2006, the screen acquisition timing determination part 154 of the display apparatus 1300 reports the initial value of the screen acquisition timing to the display screen generator 158. The display screen generator 158 inputs the terminal screen acquisition request into the terminal screen acquisition part 156 in accordance with the initial value of the screen acquisition timing. The terminal screen acquisition part 156 transmits the screen acquisition request from the communications part 162 in accordance with the terminal screen acquisition request input by the display screen generator 158.

In step S2008, the screen acquisition request transmitted in step 2006 is received by the information terminals. Each of the information terminals captures a displayed screen in accordance with the screen acquisition request transmitted from the display apparatus 1300, and transmits a screen acquisition response accompanying screen information of the captured screen to the display apparatus 1300. The communications part 162 of the display apparatus 1300 receives a screen acquisition response transmitted from the corresponding information terminal.

In step S2010, each of the screen acquisition responses received by the communications part 162 of the display apparatus 1300 is input into the terminal screen acquisition part 156. The terminal screen acquisition part 156 inputs each of the screen acquisition responses input by the communications part 162 into the display screen generator 158. The display screen generator 158 acquires the screen information from each of the screen acquisition responses input from the terminal screen acquisition part 156, and inputs the acquired screen information into the display part 160 so as to request updating the displayed screens.

In step S2012, the information terminal screen variation determination part 166 of the display apparatus 1300 computes a change in the screen information of the received screen.

In step S2014, the screen acquisition timing determination part 154 of the display apparatus 100 refers to the screen update timing determination table (5), and updates the corresponding screen acquisition timing with that corresponding to the change in the screen information computed in step S2012.

In step S2016, the screen acquisition timing determination part 154 of the display apparatus 100 waits for acquiring a screen in accordance with the corresponding screen acquisition timing set in step S2014.

In the process illustrated in FIG. 20, the display apparatus 100 may be able to set a timing for acquiring screen information of the screens from the information terminals based on the changes in the corresponding screens of the information terminals. In this configuration, the frequency of acquiring the screen information of the screens that exhibit a lower screen update frequency may be reduced. Hence, the process used for the information terminals exhibiting the lower frequency of acquiring screen information may be used for the process of acquiring the screen information of the information terminals exhibiting a high update frequency. Hence, even though the information terminal exhibiting high screen update frequency is connected, the high screen update frequency may be handled so as to improve the appearance quality of the screen.

The display apparatus is an example of a projector. The first controller is an example of the CPU 102. The first transmitter-receiver is an example of the wireless LAN module 116, and the LAN port 118. The screen information request is an example of the screen acquisition request. The second controller is an example of the CPU 201, The second transmitter-receiver is an example of the network I/F 207.

Note that the scope of the present invention is not limited by above-describe embodiments and modifications. The embodiments and modifications may include a function to capture a screen displayed by the display apparatus to generate the screen information. Further, there may be two or more display apparatuses that form the wireless communications system, and any one of the display apparatuses may include a function to capture screens displayed by the display apparatuses.

Note that a system configuration that includes the display apparatus and the information terminals connected to the display apparatus illustrated in the above-described embodiments and modifications is only an example, and various other system configuration examples may be employed based on the applications or the purposes.

The present invention is described with reference to the specific embodiments and modifications; however, these embodiments and modifications are merely examples. Various alternations, corrections, substitutions, and the like may be conceived by those skilled in the art. The apparatuses and devices according to the embodiments are described with functional block diagrams for convenience; however these apparatuses and devices may be implemented by hardware, software, or a combination of the two. The present invention is not limited to the above-described embodiments and modifications, and may incorporate variations, alterations, corrections, substitutions, and the like without departing from the sprit of the present invention.

According to the disclosed embodiments and modifications, it may be possible to provide a wireless communications technology capable of receiving screen information pieces of screens of two or more information terminals via a network to simultaneously display the respective screens of the information terminals efficiently.

The present invention is not limited to the specifically disclosed embodiments, and variations and modifications may be made without departing from the scope of the present invention.

The present application is based on and claims the benefit of priority of Japanese Priority Application No. 2014-152792 filed on Jul. 28, 2014, the entire contents of which are hereby incorporated herein by reference.

What is claimed is:

1. A wireless communications system comprising:
a display apparatus; and
a plurality of information terminals connected to the display apparatus via a network, the display apparatus and the information terminals communicating with one another via the network, wherein
the display apparatus includes
a first controller configured to set timings to request screen information of screens displayed on the information terminals, to create a screen information request to request a corresponding one of the information terminals to transmit the screen information of the screen in accordance with the timing, and to display a screen based on the screen information transmitted from the corresponding information terminal that has transmitted the screen information request; and
a first transmitter-receiver configured to transmit the screen information request created by the first controller to the information terminal corresponding to the timing, and receive the screen information transmitted from the corresponding terminal, and wherein
each of the information terminals includes
a second controller configured to capture the displayed screen to create the screen information in response to the screen information request transmitted by the display apparatus; and
a second transmitter-receiver configured to receive the screen information request transmitted by the display apparatus, and transmit the screen information created by the second controller to the display apparatus.

2. The wireless communications system as claimed in claim 1, wherein
the first controller monitors a status of the display apparatus, and sets the timing to request the screen information of the screen displayed on the each of the information terminals based on the status of the display apparatus.

3. The wireless communications system as claimed in claim 2, wherein
the first controls monitors both or one of a communications status and a load status of the display apparatus.

4. The wireless communications system as claimed in claim 1, wherein
the first controller sets the timing to request the screen information of the screen in advance with respect to each of the information terminals.

5. The wireless communications system as claimed in claim 1, wherein
the first controller sets the timing to request the screen information of the screen with respect to each of the information terminals, based on an area in which the display apparatus displays the screen displayed on a corresponding one of the information terminals.

6. The wireless communications system as claimed in claim 1, wherein
the first controller sets the timing to request the screen information of the screen with respect to each of the information terminals, based on a change in the screen information of the screen acquired from a corresponding one of the information terminals.

7. A wireless communications system including a display apparatus, and a plurality of information terminals connected to the display apparatus via a network, the display apparatus and the information terminals communicating with one another via the network, the wireless communications system comprising:
a screen acquisition timing determination module configured to set timings to request screen information of screens displayed on the information terminals;
a screen acquisition module configured to create a screen information request to request the screen information of the screen displayed on the corresponding information terminal;
a display screen capture module configured to capture the displayed screen to generate the screen information in response to the screen information request; and
a display screen generator configured to display a screen based on the screen information corresponding to the screen information request.

8. A display apparatus connected to a plurality of information terminals via a network, the display apparatus and the information terminals being capable of communicating with one another via the network, the display apparatus comprising:
a controller configured to set timings to request screen information of screens displayed on the information terminals, to create a screen information request to request a corresponding one of the information terminals to transmit the screen information of the screen in accordance with the timing, and to display a screen based on the screen information transmitted from the corresponding information terminal that has transmitted the screen information request; and
a transmitter-receiver configured to transmit the screen information request created by the controller to the information terminal corresponding to the timing, and receive the screen information transmitted from the corresponding terminal.
